(19) United States
(12) Patent Application Publication
(10) Pub. No.: US 2018/0315042 A1
(43) Pub. Date: Nov. 1, 2018

(54) ELECTRONIC ACCOUNT SHARING VIA DYNAMIC TOKENS

(71) Applicants: Aditi RUNGTA, Singapore (SG); Hisyam Nursaid Indrakesuma, Singapore (SG); Wen Zhao Cheng, Singapore (SG); Xudong Wu, Singapore (SG)

(72) Inventors: Aditi RUNGTA, Singapore (SG); Hisyam Nursaid Indrakesuma, Singapore (SG); Wen Zhao Cheng, Singapore (SG); Xudong Wu, Singapore (SG)

(21) Appl. No.: 15/498,152

(22) Filed: Apr. 26, 2017

(51) Int. Cl. G06Q 20/36; G06Q 20/32

(52) U.S. Cl. CPC G06Q 20/3672; G06Q 20/3674; G06Q 20/325

(57) ABSTRACT

Usage of another person's electronic payment device on a mobile computing device such as a mobile phone may be possible by requesting a one-time use dynamic token for a specific amount from an authority.

### BACKGROUND

Electronic accounts such as credit cards often have benefits attached to them. In some situations, only certain users may receive the best benefits as the highest desire may be to retain the best customers. However, friends of the user with the best benefits may wish to receive the benefits even if the friend is not present. Similarly, the account owner may wish to allow others to use an electronic account in certain situations with the assumption that the account owner will be promptly repaid. Currently, if a person wants to avail an offer applicable only on their friend's card, they need the friend to be physically present with them to make the payment. Also, they have to manually repay their friend either by cash or electronic banking. As the parties are often geographically separate, trying to transfer the ability to use an electronic payment device is a significant technical challenge in view of security and trust issues.

### SUMMARY

Usage of another person's electronic payment device on a mobile computing device such as a mobile phone may be possible by requesting a one-time use dynamic token for a specific amount from an authority. An application may allow a user to view relevant details of friends' electronic payment devices such as a credit card issuer name and a credit card product type, seek their approval and use the above technologies to benefit from offers and promotions normally not available to a user. After the transaction is made, the user may conduct a repayment through a direct payment service

### BRIEF DESCRIPTION OF THE DRAWINGS

FIG. 1 may be an illustration of the servers that make up the system;

FIG. 2 is a flowchart of computer executable blocks that may be executed by the servers in the system;

FIG. 3 may be a user interface where a user signs in and registers with the system;

FIG. 4 may be a user interface that may be used to select an account to be used for a transaction;

FIG. 5 may be a user interface for the responsible party to approve/deny or modify the request to use the account of the responsible party;

FIG. 6 may be a sample user interface for the user to make a payment using the account of the responsible party according to the terms set by the responsible party;

FIG. 7 is a user interface where the user selects to pay back the responsible party using one or more methods of payment;

FIG. 8 may be a high level illustration of some of the elements a sample computing environment that may be physically configured to implement the various embodiments of the method and its logical variants; and

FIG. 9 may be a sample user device 102 that is physically configured according to be part of the system.

FIG. 10 may be an illustration of the physical elements that make up a sample server 104.

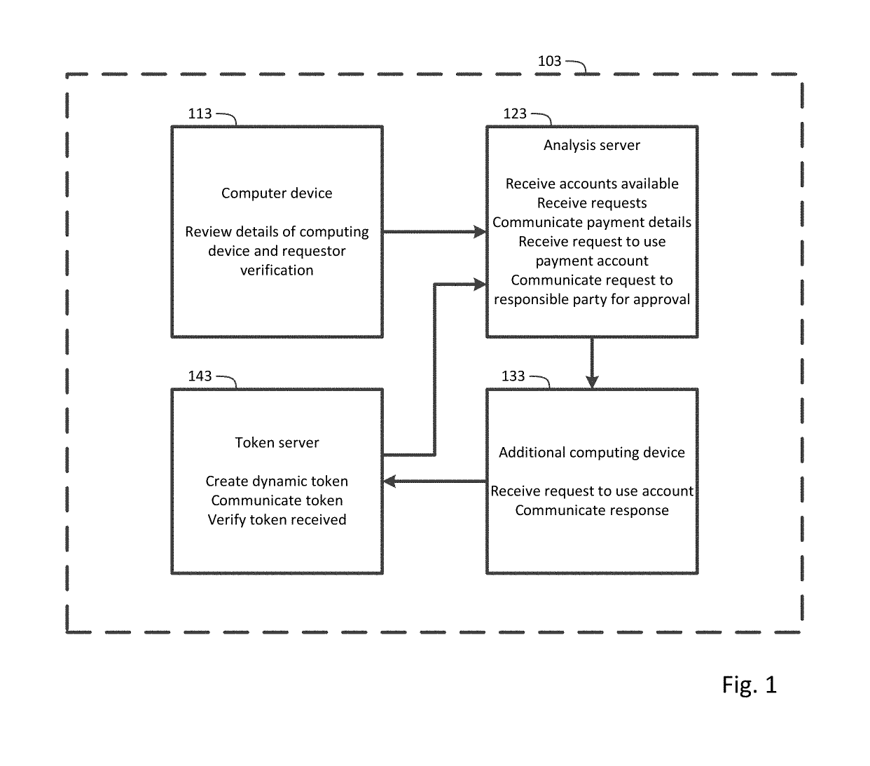

FIG. 1 may be an illustration of the various servers and computing hardware that may be part of the system 103. At a high level, a first person at a merchant may know a friend has a credit card which provides a 10% discount at that merchant. The first person may log into a web site and review the payment accounts of registered users, and look for the desired benefit. Once a payment account is selected, the first person may request to use the payment account of the selected registered user at the merchant for a given amount. The registered user may receive a message and the registered user may accept or decline the request. If the request is approved, a dynamic token may be used to complete the transaction where the dynamic token may be limited in its value and the merchants where the token may be used. The first person may then reimburse the registered account holder using a payment system.

A purpose built computing system may be used to enable and physically embody the functions of the system 103. A computing device 113 may be a device with a processor, a memory and a power source that is capable of executing computer executable instructions. It may be portable, such as a smart phone type device or a notepad or a laptop or may be less portable such as a desktop computer or a server.

The analysis server 123 may be physically configured according to computer executable instructions to execute one or more computing operations. The analysis server 123 may be physically configured and built to maximize its performance in performing the analysis functions. For example, the analysis may entail a significant amount of input and output and the input output bus on the analysis server may be designed to handle the increased throughput.

The token server 143 may be specially designed and built to generate and track tokens. Tokens may be used as proxies for actual personal account numbers. The actual personal account numbers may not be communicated but a token may be communicated instead. The token may be for a single use for a period of time and may be matched to a personal account number instead of the token server. When a transaction is made, the token is returned to the token server to be verified as being authentic, for a given amount and for a specific merchant.

The servers 123 and 143 may be physically separate or may be part of one computing device. For example, a server may operate on a single processor in a multiple processor device. Similarly, the server may be a virtual server which may operate in a cloud based manner where some functions are executed on a server in a first location and other functions are executed on a server in a different location. The physical embodiment of the servers may take many forms and is not necessarily limited to any form factor.

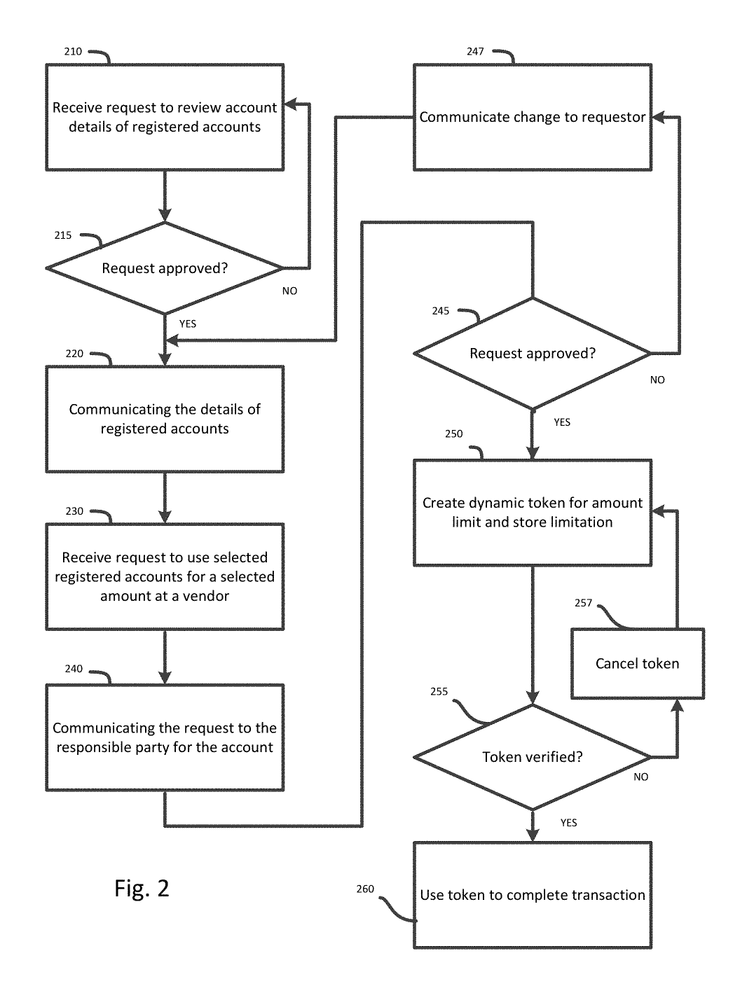

FIG. 2 may illustrate an electronic payment method using the various servers as will be described. At block 210, an analysis server 123 may receive a request from a computing device 113 to review details of registered electronic payment accounts. The details may include perks of an electronic payment account such as discounts, points, gifts, prizes, cash back, coupons, etc.

The electronic payment accounts may have a variety of forms and functions. In one embodiment, the electronic payment account may be a credit card or a debit card. In additional embodiments, the electronic payment account may be an account number that contains value such as a bank account or a brokerage account. In yet another embodiment, the electronic payment account may represent points that have value such as airline reward points, hotel reward points, etc. In yet another embodiment, the account may be a block-chain type account such as bit-coin or other linked and encrypted accounts that represents value.

Users may register their payment accounts in a variety of ways. In one embodiment, the users may use a secure log in to input the necessary information to be part of the system such as a personal account number, an expiration date, a name and the perks that are associated with the account. In addition, the user may desire to make a nickname for the account such that users may not know the actual owner of the account.

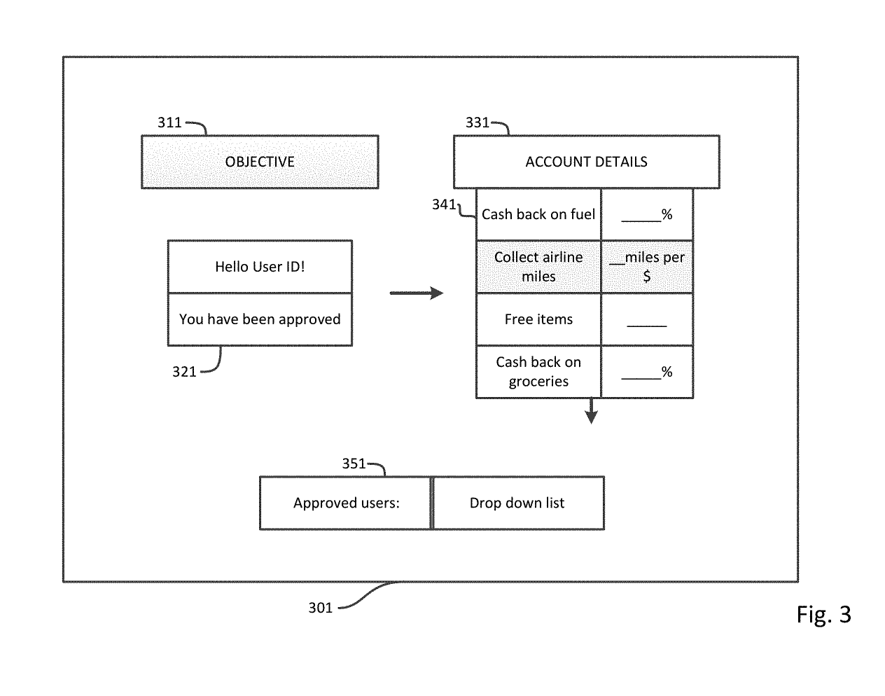

FIG. 3 may be an illustration of a sample user interface 301 to add an account assuming a user has been approved 321. The user may select an objective 311 for the account, such as cash back, freebies, airline miles, etc. The user may add relevant account details 331 for one or more accounts such as the specific perks 341 for each account. For example, a certain account may provide the perk 341 of providing some cash back on fuel.

Moreover, the user may make the account and perks available only to certain approved users 351 such that the risk of fraud may be reduced. As an example, a parent may only make an account be available for a child. In such an embodiment, identification information for approved users may also be entered. The identification information may take on a variety of forms such as the nick name of the approved user, a unique email address, a unique phone number, a user name, etc.

In other embodiments, a user may allow an account to be available based on a variety of factors. For example, a user may want their card to be available at grocery stores but not at gas stations. Similarly, geographic limitations may be placed on the account. Of course, other limitations are possible and are contemplated. The limitations may be available through a list or drop down menu for the ease of the user.

The request may include electronic computing device identification and requestor's verification which may be used as part of the system. For example, a payment token may require that it be used on a specific electronic computing device to ensure the token is only used by the requestor. Similarly, the requestor's information may be required to be a match before the token will be available for use.

At block 215, the method in the analysis server 123 may determine if the request to use the payment system by the requestor has been approved. The determination may have one or more checks as part of the determination. One determination may be whether the electronic computing device identification is registered with the system 103. If the identification does not match, use of the system 103 may be denied as the system may require that the same device that is registered with the system be used with the system.

In addition, the requestor may be verified. A profile of the requestor may be stored in the system. The profile may take on a variety of aspects. In some embodiments, the profile may be a user name and a password. In additional embodiments, the electronic computing device identification may be associated with the user. In additional embodiments, additional identification of the user may be used such as a fingerprint, an iris scan, or other biometric identification. In yet additional embodiments, the various elements of the profile may be matched to ensure the user is the registered user. As an example, a user fingerprint and electronic computing device identification may have to match.

At block 220, in response to the request of the requestor being approved by the analysis server 113, the details of the registered electronic payment accounts may be communicated to the computing device. The details of the registered electronic payment accounts to the computing device may include identification details for each of the electronic payment accounts and perks for each of the electronic payment accounts. The identification details may vary depending on the situation. For example, a mother may allow her credit card be available to a child and the card may be labeled as “Mom's Visa.” In other embodiments, the account may be labeled with a nickname such as “Jamie's Visa” where system users may or may not recognize Jamie. In other examples, users may use catchy nick names to try to make their payment account stand out and be used by more system users.

The perks of an electronic payment account may include benefits from using a specific electronic payment account such as discounts, points, gifts, prizes, cash back, coupons, etc. In another aspect, some accounts may be settled faster than others and the settlement time may be noted as a perk. As an example, some electronic funds transfers may be settled immediately which may be desirable. In another example, credit card transactions may have a period where the transaction may be stopped or voided.

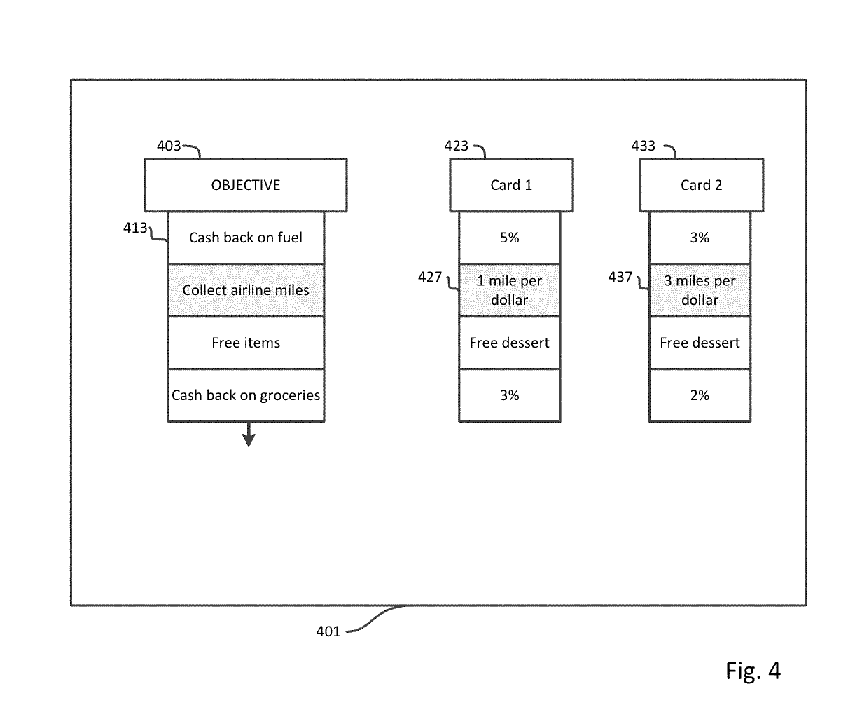

FIG. 4 may be an illustration of a user interface 401 where a user may select one account from a plurality of accounts. In FIG. 4, an objective 403 may be selected. In some embodiments, a drop down box of possible objectives 413 may be listed. Examples may include cash back on fuel, collect airline miles, free items, cash back on groceries, etc. In some embodiments, a plurality of objectives may be selected and the objectives may be ranked in a priority order.

In response, an algorithm may be used to locate accounts that are available and have been determined by the algorithm to be good matches to the selected objective or matches above a threshold. FIG. 4 may be an illustration 401 of accounts being presented for a user for selection in view of the objective selected. In FIG. 4, collect airline miles may be the first objective 413. The algorithm may score the available accounts and may list the accounts with the highest score. Card 1 (423) may provide 1 mile per dollar (427) while card 2 (433) may provide 3 miles per dollar (437) which would make card 2 (433) appear to be a better match. At the same time, card 1 (423) may provide 5% cash back on fuel while card 2 (433) only provides 3% cash back on fuel so card 2 (433) may be a better selection if cash back on fuel was selected as the main objective 403.

In yet another example, an electronic account may be a form of a loan wherein the money may need to be paid back over a period of time in exchange for paying interest on the loan amount balance. In such an embodiment, the interest rate or APR may be displayed and a user may select the lowest interest rate or APR. Similarly, the payback term may matter to some users such as when a user desires a longer pay back term. The user may be able to select terms as part of the displayed perks.

In yet another aspect, the amount of the funds available may be displayed. The funds may be available for all merchants or for such merchants. Similarly, the funds may be available for all users or some users. The communication of the account details may include the relevant funds information.

As mentioned previously, the details may be user specific. In one embodiment, the UI may be set in advance to display some default values or some default cards such as often used accounts, accounts for groceries, accounts for fuel, etc. In another embodiment, the defaults may be merchant specific or amount specific or good specific. In yet another aspect, a user may be able to set parameters and search accounts for the desired features. For example, a user may search for accounts that provide the greatest discount or the most valuable free items.

As briefly mentioned, not all the accounts in the system may appear for all users. For example, an account for a parent may only show up for children of that parent and not to all users of the system. Similarly, users may only allow their account to be used by a circle of friends that have been indicated in the enrollment user interface. Others may be open to having virtually all user access their accounts.

At block 230, a request from the computing device 113 may be received at the analysis server 123 to use a selected registered electronic payment account for a specific amount limit. The request also may include the specific merchant for which the funds will be used. It also may include the amount maximum to be used.

At block 240, the request may be communicated from the analysis server 113 to a responsible party of the selected registered electronic payment account for approval. The request may be communicated in a variety of ways. In some embodiments, the communication may be an email, a SMS message or a phone call. In other embodiments, the system user interface may be part of an application on a computing device and the app may awaken and notify the user of the pending request.

The communication may display some relevant information such that the responsible party may make an informed decision on whether to approve the payment. For example, the message may include a user name of the person making the request, the value requested, the merchant where the value is to be used, etc.

In response, the responsible party using the additional computing device 133 may approve the request and communicate an approval, deny the request and communicating a denial or modify the request and communicating the modified request. The modification may be a change to the information communicated such as the value available or the permitted merchants. Further, if the account holder does not respond in a given period of time, a denial may be communicated.

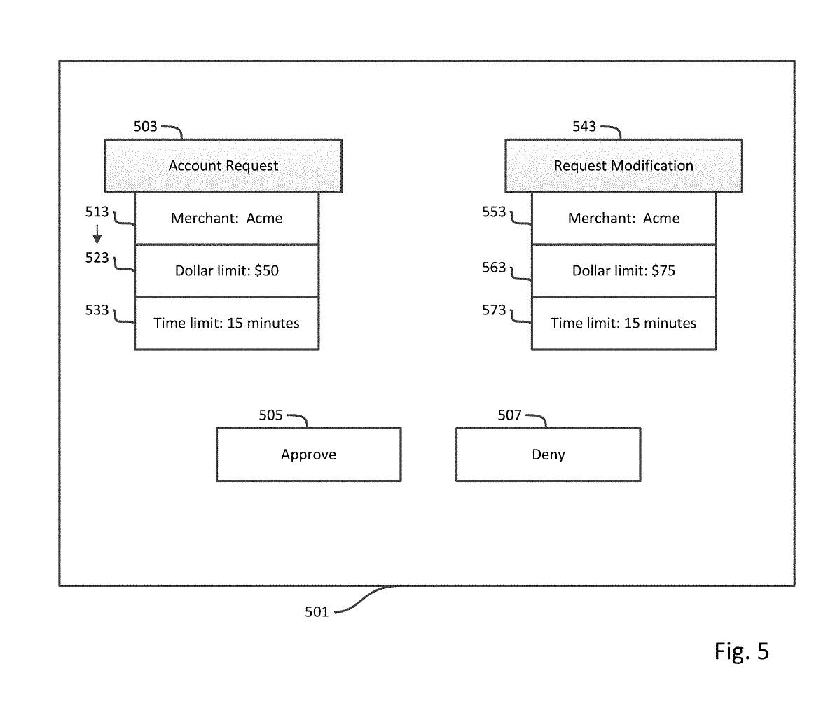

FIG. 5 may be an illustration of a user interface 501 for approving/denying/modifying a request 503 to use an account. The user interface may illustrate the proposed use along with the relevant details such as the merchant 513, the dollar limit 523 and the proposed time limit 533. The user may select to approve the transaction 505, reject the transaction 507 or may select to modify the transaction 543 such as modifying the merchant 553, modifying the dollar limit 563 or modifying the time limit 573 to complete the transaction.

It should be noted the responsible party need not be another human. The responsible party may be another computing device that follows computer executable instructions or rules for approval, denial or modification. The instructions may be preset.

In another embodiment, the response may be adjusted by a learning algorithm based on past behaviors of a human. For example, if a human consistently denies request for more than $50, the algorithm may learn to deny similar requests. In some embodiments, a responsible party may set guidelines and the algorithm may apply the guidelines. In other embodiments, the guidelines may be learned from reviewing past requests and approvals.

At block 245, the system may determine whether the request was approved, modified or denied. If the request was approved, the method may pass control to block 250. If the request was denied or modified, at block 247 the requestor may be notified through a communication such as an email or text message or app notification and control may pass to block 220 where a requestor may review additional accounts where the decision may be favorable. In yet another aspect (not shown), the user may accept the proposed change from the responsible party and the system may continue to block 250.

At block 250, the token server 143 may create a token and communicate it the electronic computing device 113 of the requestor. A token may act like a secure key to allow the transaction to progress. In some embodiments, the token may have a one-time use code that is linked to an actual personal account number. The use code may be returned from the merchant to the token server for verification and the user's personal account number may remain secret from the merchant.

The token may be provisioned with additional data such as the specific amount limit for this transaction, the electronic computing device identification, a use time limit and the benefits of the selected registered electronic payment account. The data may be matched by the system to ensure the token was received by the intended requestor.

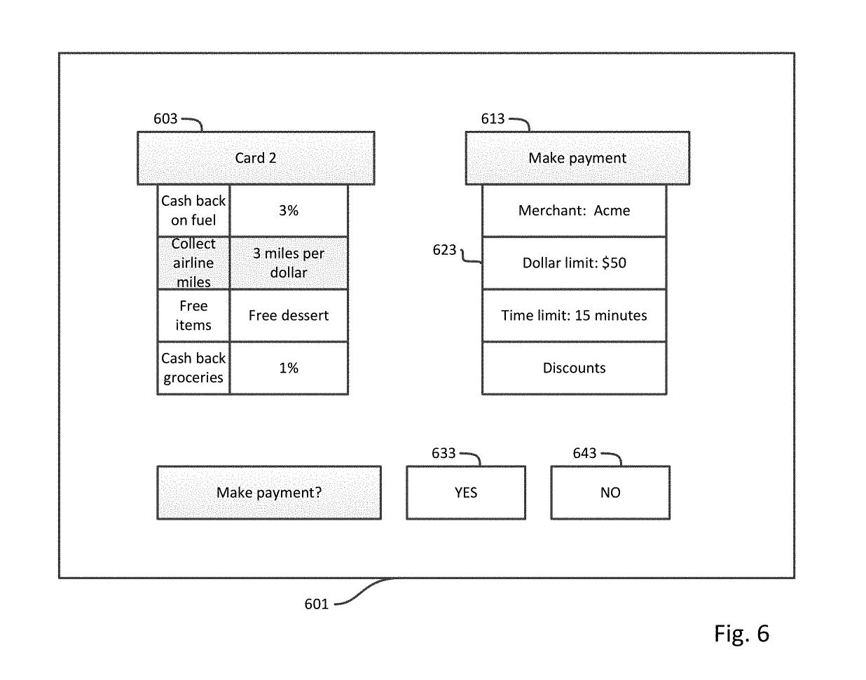

FIG. 6 may be an illustration of a user interface 601 presented to a user once an account has been approved for use by the responsible party. The details of the approval may be displayed in a user interface 601. The relevant details of the account 603 may be displayed to the user. In addition, a user may view the limitations 623 that were approved by the responsible party. For example, the responsible party may limit the use to $50 when the request was for $100. The user may then select to make the payment 633 using the account or to not make the payment 643 such as when the approved amount is too small.

At block 255, the token may be submitted to the token server 143 for verification to complete the transaction. The token will be reviewed to ensure it meets the expected details such as having a known one time use account number, being used within the expected time limits, on an expected computing device with matching computer device identification, for the expected amounts, at the expected merchant, etc. as expected. If the token is not verified, it may be canceled at block 257. At block 260, in response to the token being verified, the token may be used to complete the transaction. In some embodiments, the execution of the transaction may then be reported to the registered electronic account holder. Again, the communication may be an email, an SMS message, a notification from an app, etc.

In some embodiments, a related service may be used to initiate a transfer from the account of the electronic device holder to the registered electronic account holder such that the registered electronic account holder may be made whole. The transfer may take on a variety of forms. In some embodiments, the transfer may be a direct transfer from the requestor to the responsible party. The details required to enable the direct transfer may be entered when the parties register in the system. For example, if the direct transfer uses bank accounts, the relevant bank account details may be entered. Electronic devices may utilize a dynamic token to enable others to use a payment device. For example, if a direct payment service uses tokens, a dynamic token may be used by the direct payment service.

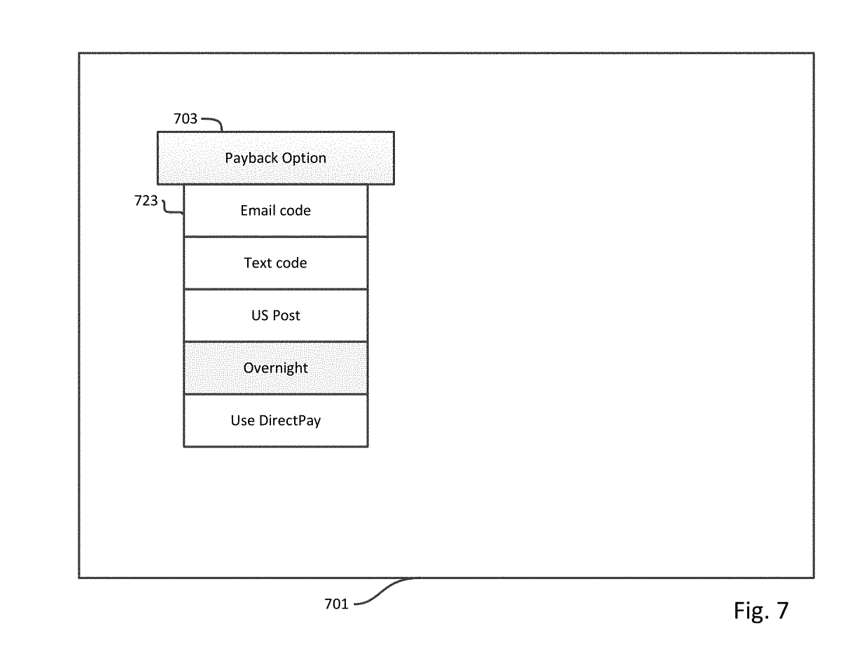

FIG. 7 may be an illustration of a user interface 701 that may be used to transfer funds back to the responsible account holder. The user may select the payback options 703 that are available to be used to reimburse the responsible party. For example, a first responsible user may accept repayment by a variety of form 723 such as an email code which may be turned into funds, a text code which may be used to transfer funds, a US Post repayment method, an overnight payment method or an electronic direct transfer. In some embodiments, the user may use one payment method to make part of the repayment and another payment method to make another part of the payment. Once the transfer is complete, the details may be communicated to the user and to the responsible party.

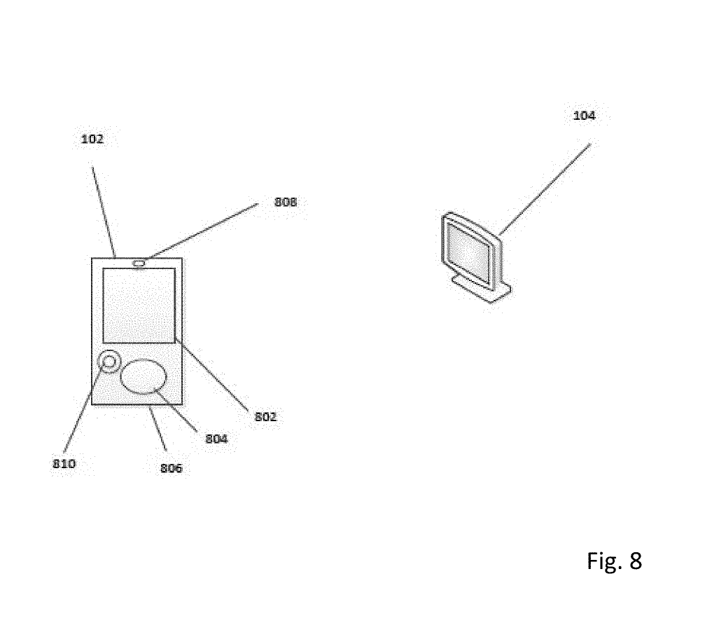

FIG. 8 may be a high level illustration of some of the elements a sample computing environment that may be physically configured to implement the various embodiments of the method and its logical variants. A user device 102 in the computing environment may store a software payment application that may be accessed in a variety of ways. There may be various versions of the application to take advantage of the benefits of different computing devices, different languages and different API platforms. In some embodiments, the entire system 103 may be accessed through a portable computing device 102 such as a smart phone and the desired activities directed toward clients may occur using a portable computing device 102.

The user device 102 may have a display 802 which may or may not be a touch sensitive display. More specifically, the display 802 may have a capacitance sensor, for example, that may be used to provide input data to the user device 102. In other embodiments, an input pad 804 such as arrows, scroll wheels, keyboards, etc., may be used to provide inputs to the user device 102. In addition, the user device 102 may have a microphone 806 which may accept and store verbal data, a camera 808 to accept images and a speaker 810 to communicate sounds.

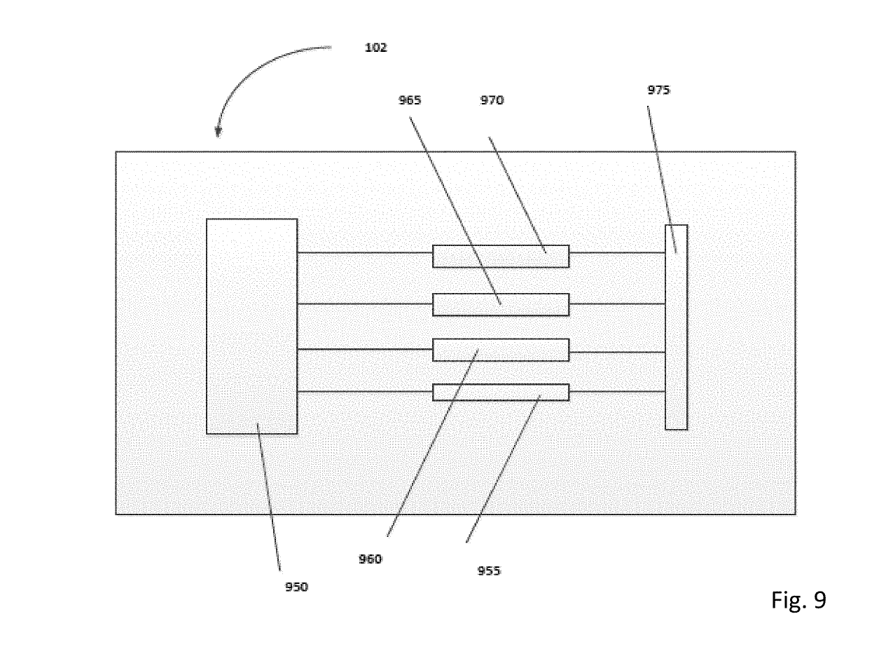

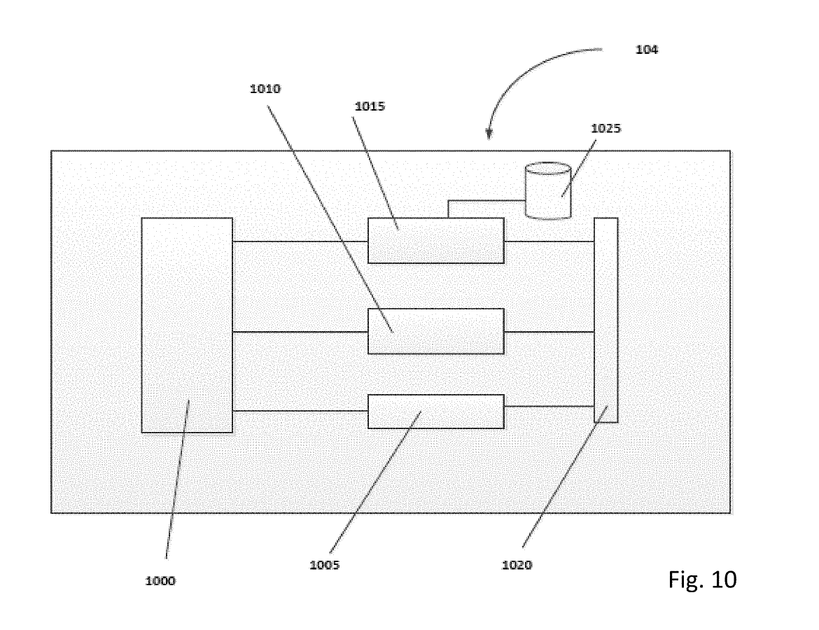

The user device 102 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the server 104 or through a wireless network, e.g., Bluetooth, etc. FIG. 9 may be a simplified illustration of the physical elements that make up a user device 102 and FIG. 10 may be a simplified illustration of the physical elements that make up the server 104.

FIG. 9 may be a sample user device 102 that is physically configured according to be part of the system. The user device 102 may have a processor 950 that is physically configured according to computer executable instructions. It may have a portable power supply 955 such as a battery which may be rechargeable. It may also have a sound and video module 960 which assists in displaying video and sound and may turn off when not in use to conserve power and battery life. The user device 102 may also have volatile memory 965 and non-volatile memory 970. There also may be an input/output bus 975 that shuttles data to and from the various user input devices such as the microphone 806, the camera 808 and other inputs 802, etc. It also may control communicating with the networks, either through wireless or wired devices. Of course, this is just one embodiment of the portable computing device 102 and the number and types of portable computing devices 102 is limited only by the imagination.

An example of the physical elements that make up a server 104 such as the analysis server 123 or token server 143 may be further illustrated in FIG. 10. Some of the physical elements may be located in other devices, depending on processing needs. The server 104 may have a processor 1000 that is physically configured according to computer executable instructions. It may also have a sound and video module 1005 which assists in displaying video and sound and may turn off when not in use to conserve power and battery life. The server 104 may also have volatile memory 1010 and non-volatile memory 1015. And as mentioned previously, each server may be physically built to meet the specific identified task.

In some examples, the server 104 may include digital storage such as a magnetic disk, an optical disk, flash storage, non-volatile storage, etc. Structured data may be stored in the digital storage such as in a database. A database 1025 may be stored in the memory 1010 or 1015 or may be separate. The database 1025 may also be part of a cloud and may be stored in a distributed manner. There also may be an input/output bus 1020 that shuttles data to and from the various user input devices such as the microphone 806, the camera 808, the inputs 804, etc. The input/output bus 1020 also may control communicating with the networks, either through wireless or wired devices. Of course, this is just one embodiment of the server 104 and the number and types of user devices 102 is limited only by the imagination.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

The user devices, terminals, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, terminals, computers and servers described herein may be running on any one of many operating systems including, but not limited to UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, terminals, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, terminals, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving data transfer. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. An electronic payment method comprising:
receiving a request at an analysis server from a computing device to review details of registered electronic payment accounts wherein the request includes electronic computing device identification and requestor verification;
in response to the request being approved by the analysis server, communicating the details of the registered electronic payment accounts to the computing device;
receiving at the analysis server a request from the computing device to use a selected registered electronic payment account for a specific amount limit;
communicating the request to a responsible party computing device of the selected registered electronic payment account;
in response to the request being approved by the responsible party on the responsible party computing device, communicating a token from a token server provisioned with:
the benefits of the selected registered electronic payment account;
the specific amount limit;
the electronic computing device identification;
a use time limit; and
in response to the token being verified on the electronic computing device, using the token to complete a transaction.

2. The payment method of claim 1, further comprising reporting the transaction to the registered electronic account holder;
using a related service to initiate a direct transfer using a transfer server from the account of the electronic device holder to the responsible party; and
communicating that the direct transfer is complete.

3. The payment method of claim 1, further comprising:
including matching the electronic computing device identification in the token to the electronic computing device identification.

4. The payment method of claim 1, further comprising matching a merchant identification in the token to a merchant that executes the transaction.

5. The payment method of claim 1, further comprising matching the amount limit in the token to the value of the transaction.

6. The payment method of claim 1, wherein the request being approved further comprises:
determining if the electronic computing device identification is registered; and
determining if the requestor verification is known and matches the electronic computing device identification.

7. The payment method of claim 1, wherein communicating the details of the registered electronic payment accounts to the computing device further comprise communicating at least one of:
identification details for each of the electronic payment accounts; and
perks for each of the electronic payment accounts.

8. The payment method of claim 7, wherein perks comprise at least one of:
discounts;
points;
gifts;
prizes;
cash back; and
coupons.

9. The payment method of claim 7, further comprising communication a maximum available on the electronic payment account.

10. The payment method of claim 1, wherein communicating the request to a responsible party of the selected registered electronic payment account further comprises displaying a message that:
the electronic computing user is requesting to use a payment device;
allowing the responsible party of the selected registered electronic payment account to:
approve the request and communicating an approval,
deny the request and communicating a denial; or
modify the request and communicating the modified request; and
if the responsible party does not respond in a given period of time, communicating a denial.

11. The payment method of claim 1, wherein the modify the request further comprises changing the value maximum for the transaction.

12. The payment method of claim 1, wherein the modify the request further comprising changing the merchant for the transaction.

13. The payment method of claim 1, wherein the token is created using a token server wherein a one-time code that is time limited is used in place of an account number.

14. The payment method of claim 10, wherein the token is submitted to the token server for verification to complete the transaction.

15. A computer system comprising:
a first computing device physically configured to review details of registered electronic payment accounts wherein the request includes electronic computing device identification and requestor verification;
an analysis server physically configured to:
receive details of registered electronic payment accounts wherein the request includes electronic computing device identification and requestor verification;
receive a request at an analysis server from the computing device to review details of registered electronic payment accounts wherein the request includes electronic computing device identification and requestor verification;
communicating the details of the registered electronic payment accounts to the computing device;
receiving a request from the computing device to use a selected registered electronic payment account for a specific amount limit (at a specific merchant);
communicating the request to a responsible party computing device of the selected registered electronic payment account;
a second computing device of a responsible party for the electronic account physically configured for:
receiving the request to use the selected registered electronic payment account;
communicating a response to the request by the responsible party on the responsible party computing device,
a token server physically configured for:
communicating a token from a token server provisioned with:
benefits of the selected registered electronic payment account;
the specific amount limit;
the electronic computing device identification;
a use time limit; and
in response to the token being verified on the electronic computing device, using the token to complete a transaction.

16. The computer system of claim 15, further comprising reporting the transaction to the registered electronic account holder;
using a related service to initiate a direct transfer using a transfer server from the account of the electronic device holder to the responsible party; and
communicating that the direct transfer is complete.

17. The computer system of claim 15, wherein the analysis server is further physically configured for executing computer executable instruction for at least one of:
matching the electronic computing device identification in the token to the electronic computing device identification;
matching a merchant identification in the token to a merchant that executes the transaction; and
matching the amount limit in the token to the value of the transaction.

18. The computer system of claim 15, wherein the analysis server is further physically configured for executing computer executable instruction for approving a request, wherein the instruction further comprise:
determining if the electronic computing device identification is registered; and
determining if the requestor verification is known and matches the electronic computing device identification.

19. The computer system of claim 15, wherein communicating the request to a responsible party of the selected registered electronic payment account further comprises displaying a message that:
the electronic computing user is requesting to use a payment device;
allowing the responsible party of the selected registered electronic payment account to:
approve the request and communicating an approval, deny the request and communicating a denial; or
modify the request and communicating the modified request; and
if the responsible party does not respond in a given period of time, communicating a denial.

20. The computer system of claim 15, wherein the modify the request further comprises at least one of:
changing the value maximum for the transaction; or
changing the merchant for the transaction.
